(19) United States
(12) Patent Application Publication
(10) Pub. No.: US 2026/0304280 A1
(43) Pub. Date: Oct. 1, 2026

(54) UE CAPABILITY OF LOCATION OR TIME-BASED TRIGGER

(71) Applicant: Samsung Electronics Co., Ltd., Suwon-si (KR)

(72) Inventors: Shiyang Leng, Little Elm, TX (US); Younhyoung Heo, San Jose, CA (US); Garam Shin, Seoul (KR)

(21) Appl. No.: 19/562,452

(22) Filed: Mar. 10, 2026

Related U.S. Application Data
(60) Provisional application No. 63/777,466, filed on Mar. 25, 2025.
(60) Provisional application No. 63/778,799, filed on Mar. 27, 2025.

(51) Int. Cl. H04W 36/36

(52) U.S. Cl. CPC H04W 36/362

(57) ABSTRACT

A method of operating a user equipment (UE) includes receiving, from a network entity, a UE capability enquiry message, and setting contents of a UE capability information message to indicate whether the UE supports conditional handover (CHO) with only a location-based or a time-based trigger event. The method also includes transmitting the UE capability information message to the network entity.

### CROSS-REFERENCE TO RELATED APPLICATIONS AND CLAIM OF PRIORITY

This application claims priority under 35 U.S.C. § 119 (e) to U.S. Provisional Patent Application No. 63/777,466 filed on Mar. 25, 2025, and U.S. Provisional Patent Application No. 63/778,799 filed on Mar. 27, 2025. The above-identified provisional patent applications are hereby incorporated by reference in their entirety.

### TECHNICAL FIELD

This disclosure relates generally to wireless networks. More specifically, this disclosure relates to a user equipment (UE) capability of location or time-based triggers.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatus and methods to support a UE capability of location or time-based triggers.

In one embodiment, a method of operating a user equipment (UE) is provided. The method includes receiving, from a network entity, a UE capability enquiry message, and setting contents of a UE capability information message to indicate whether the UE supports conditional handover (CHO) with only a location-based or a time-based trigger event. The method also includes transmitting the UE capability information message to the network entity.

In another embodiments, a method of operating a base station (BS) is provided. The method includes transmitting, to a UE, a UE capability enquiry message, and receiving a UE capability information message from the UE. Contents of the UE capability information message indicate whether the UE supports CHO with only a location-based or a time-based trigger event.

In yet another embodiment, an electronic device is provided. The electronic device includes at least one processor including processing circuitry, and memory storing instructions. The instructions, when executed by the at least one processor individually or collectively, cause the electronic device to receive, from a network entity, a UE capability enquiry message, and set contents of a UE capability information message to indicate whether the electronic device supports CHO with only a location-based or a time-based trigger event. The instructions, when executed by the at least one processor individually or collectively, also cause the electronic device to transmit the UE capability information message to the network entity.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The following documents and standards descriptions are hereby incorporated by reference into the present disclosure as if fully set forth herein:
[1] 3GPP, TS 38.300 v18.4.0, 5G; NR; NR and NG-RAN Overall Description; Stage 2.
[2] 3GPP, TS 38.331 v18.4.0, 5G; NR; Radio Resource Control (RRC); Protocol specification
[3] 3GPP, TS 38.321 v18.4.0, NR; Medium Access Control (MAC) protocol specification.
[4] 3GPP, TS 38.304 v18.4.0, NR; User Equipment (UE) procedures in Idle mode and RRC Inactive state.
[5] 3GPP, TS 38.306 v18.5.0, NR; User Equipment (UE) radio access capabilities.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure for UE capability reporting according to embodiments of the present disclosure;

FIG. 5 illustrates an example method to support a UE capability of location or time-based triggers according to embodiments of the present disclosure; and

FIG. 6 illustrates another example method to support a UE capability of location or time-based triggers according to embodiments of the present disclosure.

### DETAILED DESCRIPTION

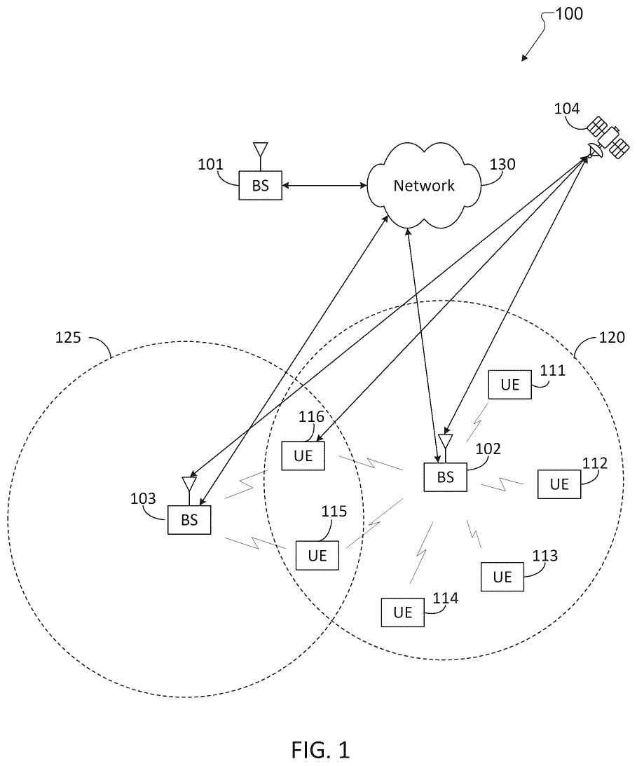

FIGS. 1 through 6, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to common fronthaul and/or backhaul connections. The BSs can also be on board the communication satellite(s) 104. Various of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Taking into account the capabilities of providing wide coverage and reliable service, an NTN is envisioned to ensure service availability and continuity ubiquitously. For instance, an NTN can support communication services in unserved areas that cannot be covered by other terrestrial networks (TNs), in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof, for to support a UE capability of location or time-based triggers. In certain embodiments, one or more of the gNBs 101-103 includes circuitry, programing, or a combination thereof, to support a UE capability of location or time-based triggers in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

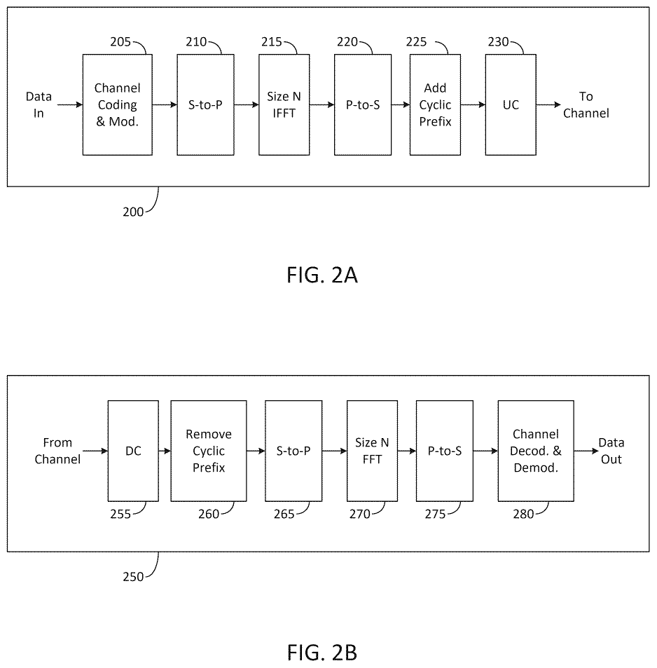

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support a UE capability of location or time-based triggers as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network.

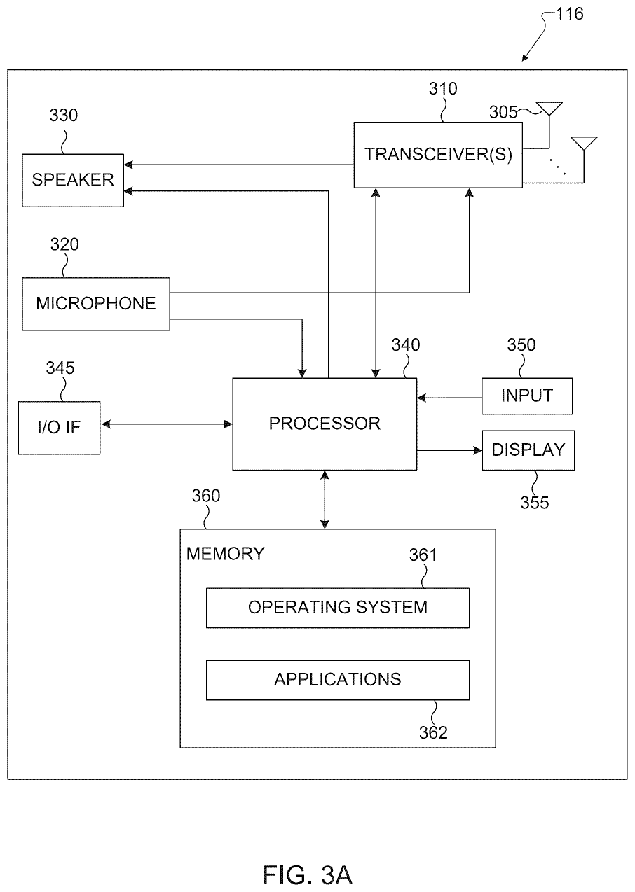

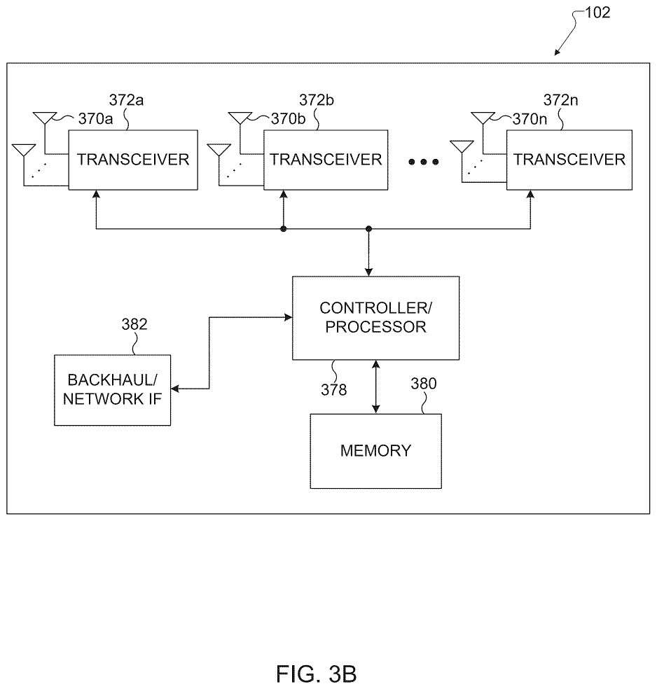

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes to support a UE capability of location or time-based triggers as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support a UE capability of location or time-based triggers as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted, and additional components could be added according to particular needs.

The Third-Generation Partnership Project (3GPP) has developed technical specifications and standards to define a fifth generation (5G) radio-access technology, known as 5G New Radio (NR). In the Release 17 NR specifications (Rel-17), NTNs are supported as a vertical functionality by 5G NR. In some embodiments, an NTN provides non-terrestrial access to a UE by way of an NTN payload (e.g., a satellite) and an NTN Gateway. The NTN payload transparently forwards the radio protocol received from the UE (via a service link [i.e., a wireless link between the NTN payload and UE]) to the NTN Gateway (via a feeder link [i.e., a wireless link between the NTN Gateway and the NTN payload]) and vice-versa. Considering their capability of providing wide coverage and reliable service, NTNs are envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

To support NTNs in 5G NR, it desirable introduce or enhance various features to accommodate the nature of radio access to an NTN that is different from terrestrial networks (TNs), such as large cell coverage, long propagation delay, and a non-static cell/satellite. In order to enable radio access to NTN, UEs needs to support certain new or enhanced features for various application scenarios, such as conditional handover (CHO).

In some embodiments, an NTN can support the following trigger conditions, upon which a UE may execute a CHO to a candidate cell, (for example, similar as described in 3GPP TS 38.331):
A Radio Resource Management (RRM) measurement-based event A3/A4/A5:
   CondEvent A3: Conditional reconfiguration candidate becomes amount of offset better than PCell/PSCell;
   CondEvent A4: Conditional reconfiguration candidate becomes better than absolute threshold where condEventA4 can also be used for current PSCell (i.e., in case it is configured as candidate PSCell for CondEvent A4 evaluation) for CHO with candidate SCG(s) case;
   CondEvent A5: PCell/PSCell becomes worse than absolute threshold1 AND Conditional reconfiguration candidate becomes better than another absolute threshold2.
A time-based trigger condition:
   CondEvent T1: Time measured at UE becomes more than configured threshold t1-Threshold but is less than t1-Threshold+duration.
A location-based trigger condition:
   CondEvent D1: Distance between UE and a reference location referenceLocation1 becomes larger than configured threshold distance ThreshFromReference1 and distance between UE and a reference location referenceLocation2 of conditional reconfiguration candidate becomes shorter than configured threshold distance ThreshFromReference2;
   CondEvent D2: Distance between UE and the serving cell moving reference location determined based on movingReferenceLocation and its corresponding satellite ephemeris and epoch time broadcast in SIB19 becomes larger than configured threshold distance ThreshFromReference1 and distance between UE and a moving reference location determined based on referenceLocation and its corresponding satellite ephemeris and epoch time for the conditional reconfiguration candidate provided in the associated MeasObjectNR becomes shorter than configured threshold distance ThreshFromReference2.

In Rel-17, for NTN CHO, a time-based or a location-based trigger condition is always configured together with one of the measurement-based trigger conditions (CHO events A3/A4/A5) as defined in 3GPP TS 38.331. For CHO, if the network configures condEventD1 or condEventT1 for a candidate cell, the network configures a second triggering event condEventA3, condEventA4 or condEventA5 for the same candidate cell. The network does not configure both condEventD1 and condEventT1 for the same candidate cell.

In the Release 18 NR specifications (Rel-18), for NTN CHO, time-based or location-based trigger conditions may be configured independently from the RRM measurement-based trigger conditions for NTN CHO in some scenarios (e.g., when the service discontinuity gap time length is zero or negligible). The network configures at most one from condEventD1, condEventD2 or condEventT1 for the same candidate cell.

Presently, when a Rel-17 UE is connected to a Rel-18 gNB which configures a location-based or time-based trigger event only, the Rel-17 UE may assume that this is an incorrect configuration based on Rel-17 NTN CHO specifications. To overcome this lack of non-backward compatible issue, various embodiments of the present disclosure provide mechanisms for a reporting a UE capability for CHO with only one of a location or time-based trigger so that the network does not configure a Rel-18 CHO with only a location or time-based trigger if the UE does not support a CHO with only a location or time-based trigger.

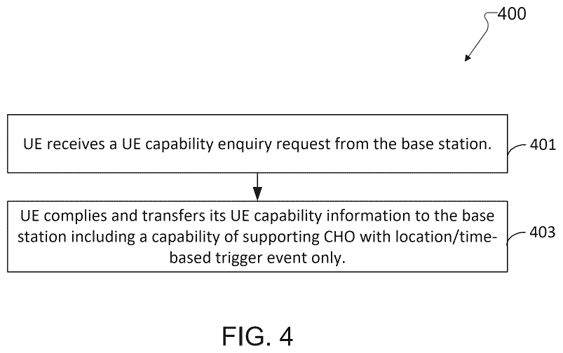

FIG. 4 illustrates an example procedure for UE capability reporting 400 according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure for UE capability reporting could be used without departing from the scope of this disclosure.

In the example of FIG. 4, the procedure 400 begins at operation 401. At operation 401, a network (for example, via a BS such as gNB 102 of FIG. 1) initiates a UE capability transfer procedure to a UE (such as UE 116 of FIG. 16) in an RRC_CONNECTED state by sending a UE capability enquiry message when to acquire additional UE radio access capability information from the UE. In some embodiments, the network retrieves UE capabilities only after AS security activation. In some embodiments, the network does not forward UE capabilities that were retrieved before AS security activation to the core network (CN).

At operation 403, upon the UE receiving the UE capability enquiry message from the network, the UE sets the content of UE capability information message and submits the UE capability information message to lower layers for transmission.

In some embodiments, for a UE without support for CHO with only a location or time-based trigger event, if the network configures condEventD1 or condEventD2 or condEventT1 for a candidate cell for CHO, the network configures a second triggering event condEventA3, condEventA4 or condEventA5 for the same candidate cell. In embodiments such as these, if the UE receives a CHO configuration for a candidate cell, for which the CHO execution condition contains a location/time-based event (e.g., condEventD1 or condEventD2 or condEventT1) and an RRM measurement event (e.g., condEventA3, condEventA4 or condEventA5), the UE evaluates both events for CHO execution condition. Upon both events being met for the execution condition, the UE executes CHO for the candidate cell.

In some embodiments, for a UE with support for a CHO with only a location or time-based trigger event, the network may configure condEventD1 or condEventD2 or condEventT1 for a candidate cell for CHO with neither condEventA3, condEventA4 or condEventA5 for the same candidate cell. In embodiments such as these, if the UE receives a CHO configuration for a candidate cell, for which the CHO execution condition contains only a location or time-based event (e.g., condEventD1 or condEventD2 or condEventT1) without an RRM measurement event (e.g., condEventA3, condEventA4 or condEventA5), the UE evaluates the location or time-based event for CHO execution condition. Upon the event being met for the execution condition, the UE executes CHO for the candidate cell.

In some embodiments, the UE capability information message may include a UE capability parameter indicating whether the UE supports a location-based or a time-based trigger event independently with no radio resource measurement/trigger. In some embodiments, inclusion of such a UE capability parameter in the UE capability information message can be optional.

For example, a UE capability parameter (e.g., ntn-condHandoverOnlyLocationTimeTrigger-r18 as shown in Table 1) can indicate whether the UE supports CHO with only a location-based or a time-based trigger event (i.e., condEventD1, condEventD2 or condEventT1 similar as described in in 3GPP TS 38.331). In some embodiments, a UE supporting this feature can also indicate the support of condHandover-r16 for NTN bands and the support of nonTerrestrialNetwork-r17. In some embodiments, the UE sets the capability value consistently for all FDD-FR1 NTN bands and all FDD-FR2 NTN bands respectively. In embodiments such as these, the inter-band location based conditional handover can be supported only when the UE sets the capability value for the source PCell and the target PCell bands. In some embodiments, the UE capability can be optional. In some embodiments, the UE capability can be defined and signalled per band. In some embodiments, the UE capability can be not applicable to signal different values for time division duplexing (TDD)/frequency division duplexing (FDD) and/or for frequency range 1 (FR1)/frequency range 2 (FR2), (i.e., “N/A” in the column by “FDD-TDD DIFF” and/or “FR1-FR2 DIFF” in Table 1).

TABLE 1
UE Capability Parameter(s)

| | | | FDD- | FR1- |
|---|---|---|---|---|
| | | | TDD | FR2 |
| Definitions for parameters | Per | M | DIFF | DIFF |
| ntn-condHandoverOnlyLocationTimeTrigger-r18 | Band | No | N/A | N/A |
| Indicates whether the UE supports conditional handover with only | | | | |
| a location-based or a time-based trigger event, i.e., condEventD1, | | | | |
| condEventD2 or condEventT1 as specified in TS 38.331. | | | | |
| A UE supporting this feature shall also indicate the support of | | | | |
| condHandover-r16 for NTN bands and the support of | | | | |
| nonTerrestrialNetwork-r17. UE shall set the capability value | | | | |
| consistently for all FDD-FR1 NTN bands and all FDD-FR2 NTN | | | | |
| bands respectively. The inter-band location based conditional | | | | |
| handover is supported only if the UE sets the capability value for | | | | |
| the source PCell and the target PCell bands. | | | | |

In some embodiments, upon receiving the UE capability enquiry message, when compiling the UE capability information message, the UE sets the parameter (e.g., ntn-condHandoverOnlyLocationTimeTrigger-r18) to the value “supported” in the UE capability information message if the UE supports conditional handover with only a location-based or a time-based trigger event (i.e., condEventD1, condEventD2 or condEventT1 similar as described in 3GPP TS 38.331). Otherwise (if the UE does not support conditional handover with only a location-based or a time-based trigger event, [i.e., condEventD1, condEventD2 or condEventT1 similar as described in 3GPP TS 38.331) the UE does not include the parameter in the UE capability information message. An example of the value being set to “supported” is shown below:
ntn-condHandoverOnlyLocationTimeTrigger-r18 ENUMERATED {supported} OPTIONAL

In some embodiments, the network respects the signalled UE radio access capability parameters when configuring the UE and when scheduling the UE. In some embodiments, for capabilities that require a consistent setting for all FDD-FR1 bands (i.e., capabilities that are supposed to be per UE), the UE sets capability values for all SUL bands with the same values as FDD-FR1 bands if an SUL band is supported by the UE.

In some embodiments, the UE can support different functionalities between FDD and TDD, and/or between FR1 and FR2. In embodiments such as these, the UE can indicate the UE capabilities as follows. In Table 1, “Yes” in the column by “FDD-TDD DIFF” and “FR1-FR2 DIFF” indicates the UE capability field can have a different value for between FDD and TDD or between FR1 and FR2 and “No” indicates if it cannot. “(Incl FR2-2 DIFF)” in the column by “FR1-FR2 DIFF” indicates the UE capability field can have a different value between FR2-1 and FR2-2. Regarding the per UE capabilities that are FDD/TDD differentiated (i.e., capabilities indicated as “Yes” in the column by “FDD-TDD DIFF”), the corresponding capabilities indicated by the FDD capability are applied to SUL/SDL if an SUL/SDL band is supported by the UE. “FD” in the column indicates to refer the associated field description. “FR1 only” or “FR2 only” in the column indicates the associated feature is only supported in FR1 or FR2 and “TDD only” indicates the associated feature is only supported in TDD and not applicable to SUL/SDL carriers. “N/A” in the column indicates it is not applicable to the feature (e.g., the signalling supports the UE having different values between FDD and TDD or between FR1 and FR2).

In some embodiments, if the UE is allowed to support different functionalities between FDD and TDD, and/or between FR1 and FR2, these functionalities can be signalled per band with the text “UE shall set the capability value consistently for all FDD-FR1 bands, all TDD-FR1 bands, all TDD-FR2-1 bands and all TDD-FR2-2 bands respectively”.

In some embodiments, for optional features, the UE radio access capability parameter can indicate whether the feature has been implemented and successfully tested. For mandatory features with the UE radio access capability parameter, the parameter can indicate whether the feature has been successfully tested. In the table above, “Yes” in the column by “M” indicates the associated feature is mandatory and “No” indicates the associated feature is optional. “CY” in the column indicates the associated feature is conditional mandatory and the condition is described in the field description and the associated feature is considered mandatory with the capability parameter, when the described condition is satisfied. “FD” in the column indicates to refer to the associated field description. Some parameters in subsequent clauses are not related to UE features and in this case, “N/A” is indicated in the column.

In some embodiments, UE capability parameters can have a hierarchical structure. In Table 1, “Per” indicates the level the associated parameter is included. “UE” in the column indicates the associated parameter is signalled per UE, “Band” indicates it is signalled per band, “BC” indicates it is signalled per band combination, “FS” indicates it is signalled per feature set (per band per band combination), “FSPC” indicates it is signalled per feature set per component carrier (per CC per band per band combination), and “FD” in the column indicates to refer the associated field description.

In some embodiments, unless otherwise specified, for dependent capabilities with prerequisite capability in a finer granularity, the UE can indicate support of the prerequisite capability in at least one finer granularity. In some embodiments, the dependent capability is supported only in the finer granularity where the prerequisite capability is supported (e.g., a UE indicating support of supportNewDMRS-Port-r16 [a dependent capability which is defined per band] should indicate at least one band combination where singleDCI-SDM-scheme-r16 [a prerequisite capability which is defined per feature set] is supported in the corresponding band). In this example, supportNewDMRS-Port-r16 is considered supported only in the corresponding band of the band combination where singleDCI-SDM-scheme-r16 is supported.

In some embodiments, a UE capability parameter (e.g., ntn-condHandoverOnlyLocationTimeTrigger) can indicate whether the UE supports CHO with only a location-based or a time-based trigger event (i.e., condEventD1, condEventD2 or condEventT1 as similar as described in 3GPP TS 38.331). In some embodiments, a UE supporting this feature can also indicate the support of condHandover-r16 for NTN bands and the support of non TerrestrialNetwork-r17. In embodiments such as these, the UE can set the capability value consistently for all FDD-FR1 NTN bands and all FDD-FR2 NTN bands respectively. In some embodiment, the inter-band location based conditional handover is supported only if the UE sets the capability value for the source PCell and the target PCell bands. In some embodiments, the UE capability parameter is optional. In some embodiments, the UE capability parameter can be defined and signalled per band, similar as shown in Table 2.

In some embodiment, for a UE capability parameter (e.g., ntn-condHandoverOnlyLocationTimeTrigger-r18), a UE supporting this feature can also indicate the support of at least a location-based or a time-based trigger event for NTN bands (e.g., condEventD1, condEventD2 or condEventT1 similar as described in 3GPP TS 38.331), or equivalently, indicate the support of at least one among locationBasedCondHandover-r17 for condEventD1 and/or locationBasedCondHandoverEMC-r18 for condEventD2 and/or timeBasedCondHandover-r17 for condEventT1.

In some embodiments, the UE capability parameter (e.g., ntn-condHandoverOnlyLocationTimeTrigger-r18) can be defined and signalled per UE, similar as shown in Table 2.

TABLE 2
UE Capability Parameter(s)

| | | | FDD- | FR1- |
|---|---|---|---|---|
| | | | TDD | FR2 |
| Definitions for parameters | Per | M | DIFF | DIFF |
| ntn-CHO-OnlyLocationTimeTrigger-r18 | UE | No | N/A | N/A |
| Indicates whether the UE supports conditional handover with only | | | | |
| a location-based or a time-based trigger event, i.e., condEventD1, | | | | |
| condEventD2 or condEventT1 as specified in TS 38.331 [9]. | | | | |
| A UE supporting this feature shall also indicate the support of at | | | | |
| least one of locationBasedCondHandover-r17 or | | | | |
| timeBasedCondHandover-r17 or | | | | |
| locationBasedCondHandoverEMC-r18. | | | | |

In some embodiments, a UE capability parameter (e.g., ntn-condHandoverOnlyLocationTimeTrigger-r18) cannot be signalled with different values for TDD/FDD or for FR1/FR2 (i.e., “No” in the column by “FDD-TDD DIFF” and/or “FR1-FR2 DIFF”).

In some embodiments, a UE capability parameter (e.g., ntn-condHandoverOnlyLocationTimeTrigger-r18) can be signalled with different values for TDD/FDD or for FR1/FR2 (i.e., “Yes” in the column by “FDD-TDD DIFF” and/or “FR1-FR2 DIFF”).

Although FIG. 4 illustrates one example procedure for UE capability reporting 400, various changes may be made to FIG. 4. For example, while shown as a series of operations, various operations in FIG. 4 could overlap, occur in parallel, occur in a different order, occur any number of times, be omitted, or replaced by other operations.

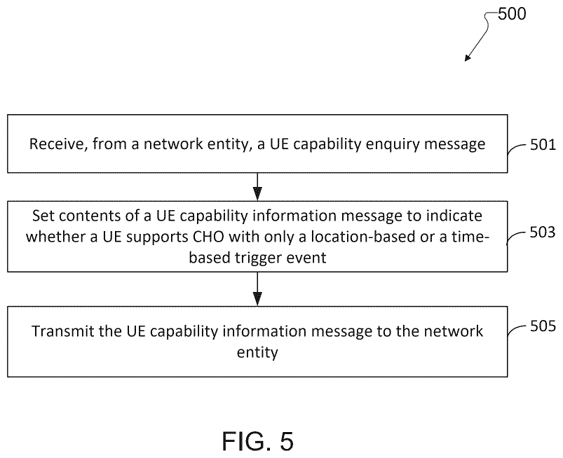

FIG. 5 illustrates an example method to support a UE capability of location or time-based triggers 500 according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a method to support a UE capability of location or time-based triggers could be used without departing from the scope of this disclosure.

In the example of FIG. 5, the method 500 begins at step 501. At step 501, a UE (such as UE 116 of FIG. 1) receives, from a network entity (such as gNB 102 of FIG. 1), a UE capability enquiry message.

At step 503, the UE sets the contents of a UE capability information message to indicate whether the UE supports CHO with only a location-based or a time-based trigger event.

At step 505, the UE transmits the UE capability information to the network entity.

In some embodiments, the contents of the UE capability information message may indicate that the UE does not support CHO with only a location-based or a time-based trigger event. In embodiments such as these, the UE may (i) receive, from the network entity, a CHO configuration including an execution condition for a candidate cell, the execution condition comprising one of a location-based or a time-based trigger event, (ii) evaluate the location-based or the time-based trigger event for the execution condition, and (iii) execute a CHO for the candidate cell when the execution condition is fulfilled.

In some embodiments, the contents of the UE capability information message may indicate that the UE does not support CHO with only a location-based or a time-based trigger event. In embodiments such as these, the UE may receive, from the network entity, a CHO configuration including an execution condition for a candidate cell, the execution condition comprising (i) a location-based or a time-based trigger event and (ii) a radio resource management (RRM) measurement-based event; evaluate (i) the location-based or the time-based trigger event and (ii) the RRM measurement-based event for the execution condition; and executing a CHO for the candidate cell when the execution condition is fulfilled.

In some embodiments, to indicate that the UE supports CHO with only a location-based or a time-based trigger event, setting the contents of the UE capability information message may include the UE setting the UE capability information message to include a UE capability parameter indicating that the UE supports CHO with only a location-based or a time-based trigger event.

In some embodiments, the UE capability information message may further include at least one of a second UE capability parameter that indicates that the UE supports location-based CHO for an NTN or a third UE capability parameter that indicates that the UE supports time-based CHO for an NTN.

In some embodiments, inclusion of the UE capability parameter indicating that the UE supports CHO with only a location-based or a time-based trigger event within the UE capability information message may be optional.

In some embodiments, the UE capability parameter may be signaled on a per UE basis.

In some embodiments, the UE capability parameter may not be signaled with different values for TDD and FDD.

In some embodiments, the UE capability parameter may not be signaled with different values for frequency range 1 (FR1) and frequency range 2 (FR2).

Although FIG. 5 illustrates one example method to support a UE capability of location or time-based triggers 500, various changes may be made to FIG. 5. For example, while shown as a series of steps, various steps in FIG. 5 could overlap, occur in parallel, occur in a different order, occur any number of times, be omitted, or replaced by other steps.

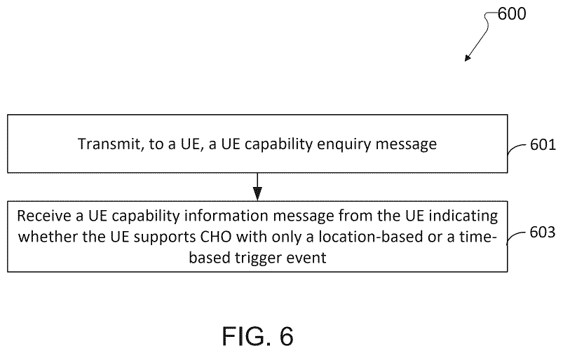

FIG. 6 illustrates another example method to support a UE capability of location or time-based triggers 600 according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a method to support a UE capability of location or time-based triggers could be used without departing from the scope of this disclosure.

In the example of FIG. 6, the method 600 begins at step 601. At step 601, a BS such as gNB 102 of FIG. 1) transmits, to a UE (such as UE 116 of FIG. 1) UE capability enquiry message.

At step 603, the BS receives a UE capability information message. Contents of the UE capability information message indicate whether the UE supports CHO with only a location-based or a time-based trigger event.

In some embodiments, the contents of the UE capability information message may indicate that the UE supports CHO with only a location-based or a time-based trigger event. In embodiments such as these, the BS may transmit, to the UE, a CHO configuration including an execution condition for a candidate cell, the execution condition comprising one of a location-based or a time-based trigger event.

In some embodiments, the contents of the UE capability information message may indicate that the UE supports CHO with only a location-based or a time-based trigger event. In embodiments such as these, the BS may transmit to the UE, a CHO configuration including an execution condition for a candidate cell, the execution condition comprising (i) a location-based or a time-based trigger event and (ii) a radio resource management (RRM) measurement-based event.

In some embodiments, to indicate whether the UE supports CHO with only a location-based or a time-based trigger event, the contents of the UE capability information message may include a UE capability parameter indicating that the UE supports CHO with only a location-based or a time-based trigger event.

In some embodiments, the UE capability information message may further include at least one of a second UE capability parameter that indicates that the UE supports location-based CHO for an NTN or a third UE capability parameter that indicates that the UE supports time-based CHO for an NTN.

In some embodiments, inclusion of the UE capability parameter indicating that the UE supports CHO with only a location-based or a time-based trigger event within the UE capability information message is optional.

In some embodiments, the UE capability parameter may not be signaled with different values for frequency range 1 (FR1) and frequency range 2 (FR2).

In some embodiments, the UE capability parameter is signaled on a per UE basis.

In some embodiments, the UE capability parameter may be signaled on a per UE basis.

In some embodiments, the UE capability parameter may not be signaled with different values for TDD and FDD.

Although FIG. 6 illustrates one example method to support a UE capability of location or time-based triggers 600, various changes may be made to FIG. 6. For example, while shown as a series of steps, various steps in FIG. 6 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method of operating a user equipment (UE), the method comprising:
receiving, from a network entity, a UE capability enquiry message;
setting contents of a UE capability information message to indicate whether the UE supports conditional handover (CHO) with only a location-based or a time-based trigger event; and
transmitting the UE capability information message to the network entity.

2. The method of claim 1, wherein:
the contents of the UE capability information message indicate that the UE supports CHO with only a location-based or a time-based trigger event; and
the method further comprises:
receiving, from the network entity, a CHO configuration including an execution condition for a candidate cell, the execution condition comprising one of a location-based or a time-based trigger event;
evaluating the location-based or the time-based trigger event for the execution condition; and
executing a CHO for the candidate cell when the execution condition is fulfilled.

3. The method of claim 1, wherein:
the contents of the UE capability information message indicate that the UE does not support CHO with only a location-based or a time-based trigger event; and
the method further comprises:
receiving, from the network entity, a CHO configuration including an execution condition for a candidate cell, the execution condition comprising (i) a location-based or a time-based trigger event and (ii) a radio resource management (RRM) measurement-based event;
evaluating (i) the location-based or the time-based trigger event and (ii) the RRM measurement-based event for the execution condition; and
executing a CHO for the candidate cell when the execution condition is fulfilled.

4. The method of claim 1, wherein to indicate that the UE supports CHO with only a location-based or a time-based trigger event, setting the contents of the UE capability information message comprises setting the UE capability information message to include a UE capability parameter indicating that the UE supports CHO with only a location-based or a time-based trigger event.

5. The method of claim 4, wherein the UE capability information message further includes at least one of a second UE capability parameter that indicates that the UE supports location-based CHO for a non-terrestrial network (NTN) or a third UE capability parameter that indicates that the UE supports time-based CHO for a non-terrestrial network (NTN).

6. The method of claim 4, wherein inclusion of the UE capability parameter indicating that the UE supports CHO with only a location-based or a time-based trigger event within the UE capability information message is optional.

7. The method of claim 4, wherein the UE capability parameter is signaled on a per UE basis.

8. The method of claim 4, wherein the UE capability parameter cannot be signaled with different values for time division duplexing (TDD) and frequency division duplexing (FDD).

9. The method of claim 4, wherein the UE capability parameter cannot be signaled with different values for frequency range 1 (FR1) and frequency range 2 (FR2).

10. A method of operating a base station (BS), the method comprising:
transmitting, to a user equipment (UE), a UE capability enquiry message; and
receiving a UE capability information message from the UE,
wherein contents of the UE capability information message indicate whether the UE supports conditional handover (CHO) with only a location-based or a time-based trigger event.

11. The method of claim 10, wherein:
the contents of the UE capability information message indicate that the UE supports CHO with only a location-based or a time-based trigger event; and
the method further comprises transmitting, to the UE, a CHO configuration including an execution condition for a candidate cell, the execution condition comprising one of a location-based or a time-based trigger event.

12. The method of claim 10, wherein:
the contents of the UE capability information message indicate that the UE does not support CHO with only a location-based or a time-based trigger event; and
the method further comprises transmitting, to the UE, a CHO configuration including an execution condition for a candidate cell, the execution condition comprising (i) a location-based or a time-based trigger event and (ii) a radio resource management (RRM) measurement-based event.

13. The method of claim 10, wherein to indicate whether the UE supports CHO with only a location-based or a time-based trigger event, the contents of the UE capability information message includes a UE capability parameter indicating that the UE supports CHO with only a location-based or a time-based trigger event.

14. The method of claim 13, wherein the UE capability information message further includes at least one of a second UE capability parameter that indicates that the UE supports location-based CHO for a non-terrestrial network (NTN) or a third UE capability parameter that indicates that the UE supports time-based CHO for a non-terrestrial network (NTN).

15. The method of claim 13, wherein inclusion of the UE capability parameter indicating that the UE supports CHO with only a location-based or a time-based trigger event within the UE capability information message is optional.

16. The method of claim 13, wherein the UE capability parameter is signaled on a per UE basis.

17. The method of claim 13, wherein the UE capability parameter cannot be signaled with different values for time division duplexing (TDD) and frequency division duplexing (FDD).

18. The method of claim 13, wherein the UE capability parameter cannot be signaled with different values for frequency range 1 (FR1) and frequency range 2 (FR2).

19. An electronic device comprising:
at least one processor including processing circuitry; and
memory storing instructions, wherein the instructions, when executed by the at least one processor individually or collectively, cause the electronic device to:
receive, from a network entity, a user equipment (UE) capability enquiry message;
set contents of a UE capability information message to indicate whether the electronic device supports conditional handover (CHO) with only a location-based or a time-based trigger event; and
transmit the UE capability information message to the network entity.

20. The electronic device of claim 19, wherein to indicate that the electronic device supports CHO with only a location-based or a time-based trigger event, to set the contents of the UE capability information message, the instructions, when executed by the at least one processor individually or collectively, cause the electronic device to set the UE capability information message to include a UE capability parameter indicating that the UE supports CHO with only a location-based or a time-based trigger event.
